(19) United States
(12) Patent Application Publication
(10) Pub. No.: US 2022/0343649 A1
(43) Pub. Date: Oct. 27, 2022

(54) MACHINE LEARNING FOR BASKETBALL RULE VIOLATIONS AND OTHER ACTIONS

(71) Applicant: Vladimir LUCIC, London (GB)

(72) Inventor: Vladimir LUCIC, London (GB)

(21) Appl. No.: 17/730,621

(22) Filed: Apr. 27, 2022

Related U.S. Application Data
(60) Provisional application No. 63/180,476, filed on Apr. 27, 2021.

(51) Int. Cl. G06V 20/40; G06V 40/20; G06V 10/82

(52) U.S. Cl. CPC G06V 20/42; G06V 40/20; G06V 10/82

(57) ABSTRACT

A rule violation in basketball or other sport is detected by capturing image data of a player of basketball and processing the image data using a trained machine-learning system. The trained machine-learning system includes a player state machine that describes allowable states of the player and a rule violation state of the player. Information extracted from the image data is applied to the player state machine to determine whether the rule violation state is active. When the rule violation state is determined to be active, an indication of such is outputted, such as by sending an alert to an official. The same techniques may be applied to coaching.

### BACKGROUND

The rules of modern sports can be complicated and difficult to enforce in an objective manner. Fast moving sports, such as basketball and hockey, are particularly susceptible to bad or missed calls. Games have been won and lost due to bad or missed calls. In addition to game officiating, perfecting certain moves in training is often a laborious task, necessarily involving other people to evaluate correctness of the moves.

### BRIEF DESCRIPTION OF THE DRAWINGS

FIG. 1 is a block diagram of a computing device configured to evaluate a participant of a sport.

FIG. 2 is a flowchart of a method of detecting a rule violation or sport action.

FIG. 3 is a flowchart of a method of detecting a specific rule violation or specific sport action.

FIG. 4 is a block diagram of a computing system configured to evaluate a participant of a sport.

FIG. 5 is a block diagram of a machine-learning system configured to evaluate a participant of a sport.

FIG. 6 is a block diagram of an example player state machine.

FIGS. 7A-7D are diagrams of an example pivoting violation tested.

FIG. 8 is a set of images of example ball detection instances.

FIG. 9 is an image showing detection of a player and determination of the pose of the player.

FIG. 10 is a set of plots of detected ball trajectory with gaps and interpolation.

FIG. 11 is a plot of detected relative positions between a player's hands and a ball.

### DETAILED DESCRIPTION

The likelihood of missed calls typically increases with complexity of the associated rules, which often involve elaborate and specific restricting of player movement while in possession of a ball.

Officiating and training can benefit from applications of machine learning, where some aspect of human involvement can be reduced and replaced by more accurate machine learning-based methods.

The present disclosure describes techniques to apply machine-learning assistance in reducing or eliminating bad or missed calls in sport. The techniques discussed herein are particularly suitable for basketball because of the relatively complex rules of that game. As such, players and fans may benefit from more objective officiating and likely better games. In addition, coaches and players can benefit from objective and instantaneous verification of certain advanced moves in practice (e.g., eurostep, spin move).

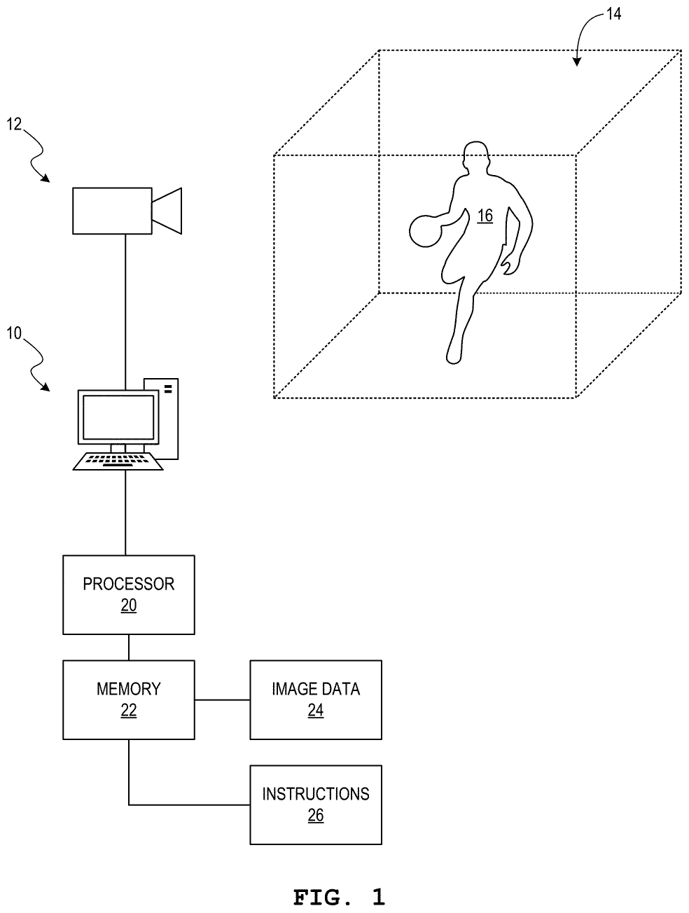

FIG. 1 shows a computing device 10, such as a desktop computer, notebook computer, server, smartphone, or similar. The computing device 10 is connected to a digital camera 12 or a set of such cameras 12. The camera 12 is aimed towards a play volume 14, in which a participant 16 of a sport is located.

The participant 16 may have in their possession equipment normally used for the sport, such as a ball, uniform, helmet, etc. The play volume 14 may include markings and objects normally found in the sport, such as boundary lines, a net, a post, a bench, a bleacher, a light, etc. The play volume 14 may include another participant, such as an opposing participant or a cooperating participant.

The camera 12 is configured to capture images of the play volume 14 including the participant 16. Any number of cameras 12 may be used with any arrangement of viewpoints. The camera 12 may capture visible light, infrared light, or similar. The camera 12 may include a depth sensor and may be an RGB-D sensor or camera. A separate depth sensor may be used. Captured data may include two-dimensional pixel data, depth data, and similar. For purposes of this disclosure, images, depth data, and/or other data captured from the play volume 14 is referred to image data. Captured image data is provided to the computing device 10.

The computing device 10 is configured to evaluate the motion of the participant 16 for conformance to motions of the sport. Motions of the sport may be defined by the rules of the sport, actions taken when participating in the sport, and so on. Evaluation of the participant's motion against rules may be performed with the goal of reducing or minimizing the participant's rule violations. Evaluation of the participant's motion against other actions may be performed with the goal of conforming to expectations of the sport (which may be sportsmanship rather than actual rules), training the participant to improve their performance at the sport, or similar.

The computing device 10 may also be configured to determine which participant 16, if any, has possession of the ball or other sports object. For example, when assisting with the officiating of a game, the computing device 10 may determine that a specific player has the ball and therefore that certain rules are in effect for that player (e.g., traveling in basketball). The computing device 10 may be configured to determine a participant on the basis of text recognition (e.g., for jersey numbers and names), facial recognition, gait recognition, or similar.

The computing device 10 includes a processor 20 and memory 22 connected to the processor 20.

The processor 20 may include a microcontroller, a microprocessor, a field-programmable gate array (FPGA), an application-specific integrated circuit (ASIC), a central processing unit (CPU), or a similar device capable of executing instructions. The processor 20 and memory 22 may be located at the same computing device 10 or separated into multiple communicating computing devices 10. The processor 20 and memory 22 may be integrated together in the same device or on the same chip.

The memory 22 may include a non-transitory machine-readable medium that may be an electronic, magnetic, optical, or other physical storage device that encodes executable instructions. The machine-readable medium may include, for example, random access memory (RAM), read-only memory (ROM), memory, a magnetic storage drive, an optical device, or similar.

The memory 22 may store image data 24 of the participant 16 and other content of the play volume 14 as captured by the camera 12. The image data 24 may include a sequence of still images, video, video frames, or similar. Image data 24 may include depth information.

The memory 22 may further store instructions 26 relating to a trained machine-learning system configured to analyze the image data 24. The instructions 26 are executable by the processor 20.

The instructions 26 may cause the processor 20 to control the camera 12 to capture the image data 24. In other examples, the image data 24 is provided another way.

The instructions 26 process the image data 24 using the trained machine-learning system to obtain a result and output the result.

The trained machine-learning system may include a neural network, such as a Convolutional Neural Network (CNN) or Recurrent Neural Network (RNN). In other examples, other Artificial Intelligence (AI) techniques may be used. The trained machine-learning system may be trained from image data of rule violations and/or desired actions related to the sport.

Accordingly, the participant 16 may be informed of actions that violate the rules of the sport based on machine-learning analysis of image data captured of the participant. In the same vein, the participant 16 may be trained according to model actions or other actions that are not necessarily rule violations but may be desired goals of the participant 16 or their coach.

The image data 24 may be processed by the instructions 26 in real time or near real time, so that a coaching or officiating intervention may be made soon after the rule violation or other action. In other examples, image data 24 may be processed by the instructions 26 after a game or practice and feedback may be provided to an official, coach, or the player at a later time.

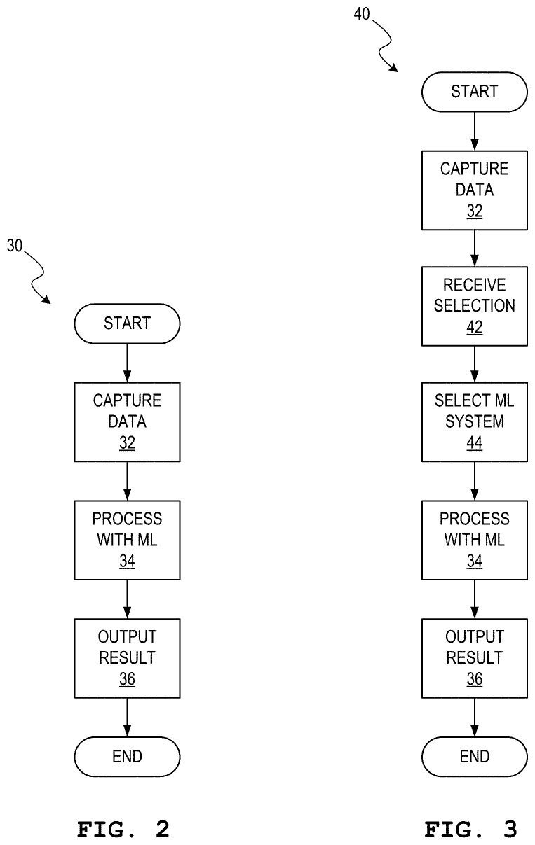

FIG. 2 shows a method 30 of detecting a rule violation. The method 30 may be implemented as instructions executable by a device or system as described herein, such as the computing device 10.

At block 32, image data is captured. Image data may include visible information, infrared information, depth information, and similar.

At block 34, the captured data is processed by a trained machine-learning system that has been trained to recognize a sport rule violation. Any number of sport rule violations may be trained. For example, in basketball, the machine-learning system may be trained with image data describing charging, double dribble, traveling, and so on. This may assist the participant in practicing sport actions, such as a Euro-step, a step-back shot, a spin move, and so on, in a way that avoids violating the rules of the sport.

At block 36, the trained machine-learning system outputs a result of its processing. The result may include an indication of a sport rule violation that classifies the captured image data. In other examples, the result may include a list of sport rule violations, each with a degree of classification resulting from the captured image data. The result may be outputted to a computing device of an official of the sport, to supplement the official's judgement during a live game. For example, machine-learning results may be continually generated and an official maybe alerted in real-time in the case of violation, while still leaving the final call to the official's discretion. Thus, classifications that score high are actively brought to the attention of an official, for example, by a push notification transmitted to a device carried by the official.

In other examples, the result may be outputted to a computing device of a coach of the participant, so that the coach can assist the participant in improving their action to avoid violating the rule.

In another example, the machine-learning system is trained to recognize a sport action that a participant wishes to practice or improve, where such action may not necessarily violate a rule. Any number of sport actions may be trained. The machine-learning system may be trained with well-executed or model representations of the sport actions, such as those made by professional players. The result, at block 36, may indicate the degree to which the sport action is classified as the sport action. The result may include a list of sport actions, each with a degree of classification resulting from the captured image data. The result may be outputted to a computing device of a coach of the participant of the sport.

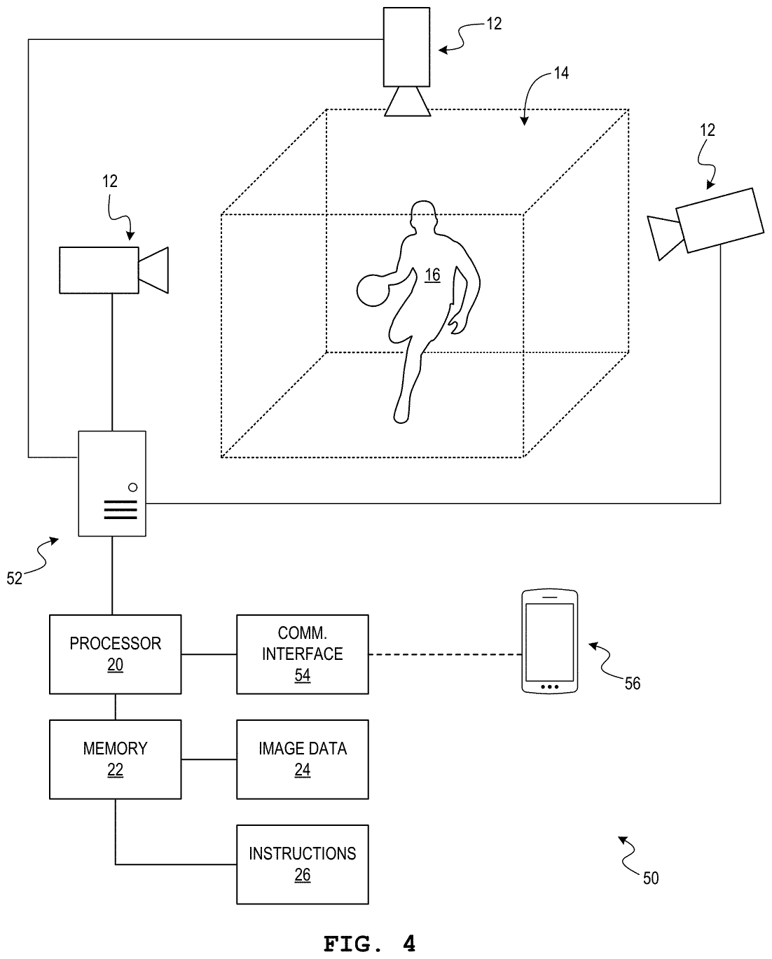

FIG. 3 shows a method 40 of detecting a rule violation. The method 40 may be implemented as instructions executable by a device or system as described herein, such as the computing device 10. The description of the method 30 may be referenced for details not repeated here.

The method 40 may be used when a specific sport rule is to be trained or detected, while the method 30 may be more general purpose. For example, a particularly problematic rule may be monitored with the method 40 to supplement training or officiating instead of generally monitoring all rules as could be implemented by the method 30. That is, a specific rule may be assisted by machine learning while other rules may rely entirely on human observation. In another example, different machine-learning systems are created for different rules, and the method 40 may be used to select among different machine-learning systems. For example, a machine-learning system that detects the basketball goaltending may not be selected until a player has released the ball. As such, processing resources can be assigned where needed based on the flow of a game.

At block 42, a specific sport rule violation is selected as associated with the image data. The sport rule violation may be selected by a human operator. This may allow a human operator to test image data against an individual rule of the sport.

At block 44, the selected sport rule violation is used to select a machine-learning system that has been trained for the specific sport rule. The captured data is processed by the selected machine-learning system, at block 34. Using multiple rule-specific machine-learning systems may allow for such systems to be more readily or quickly trained. Further, rules that are problematic for coaches or officials for the specific sport may be augmented by machine learning, while other rules that are less problematic may be evaluated using conventional techniques.

In another example, various machine-learning systems are trained to recognize specific sport actions that are not necessarily rule violations, and a selected sport action is received at block 42. The correspondingly trained machine-learning system is selected at block 44. The result may be outputted to a computing device of a coach of the participant of the sport, at block 36.

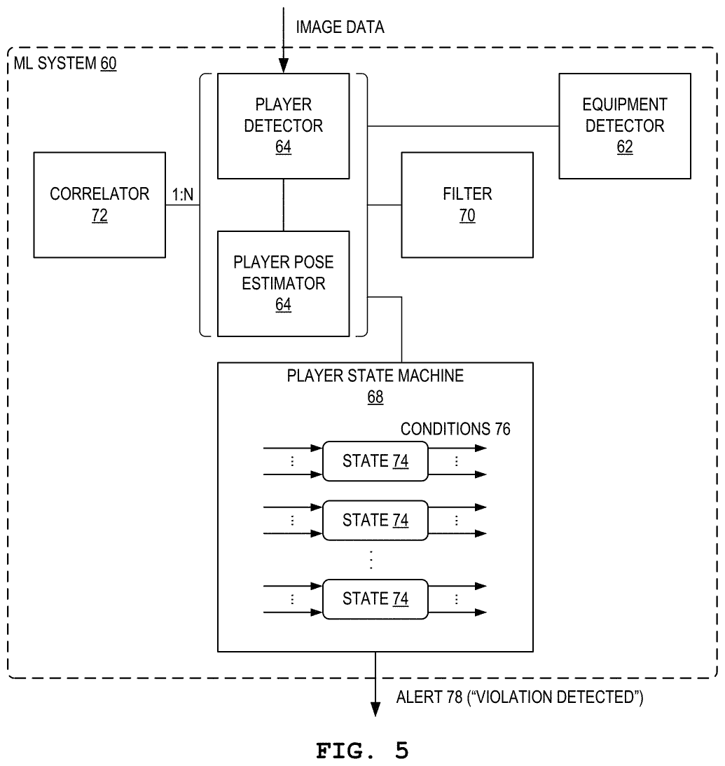

FIG. 4 shows a system 50 that includes a server 52. The description of the computing device 10 may be referenced for details of the server 52 not repeated here.

The server 52 is connected to multiple cameras 12 at different viewpoints with respect to a play volume 14. Each camera 12 may have a different position, orientation, etc. As such, instructions 26 that carry out the trained machine-learning system to recognize rule violations or/or other actions may reference image data from the various viewpoints.

The server 52 may include a communications interface 54 to provide for data communications with a remote computing device 56, such as a notebook computer or smartphone. The communications interface 54 may include a wired or wireless network adaptor or similar device. The instructions 26 may be configured to output the result of the processing of the machine-learning system to the remote computing device 56, which may be operated by an official, coach, or similar individual.

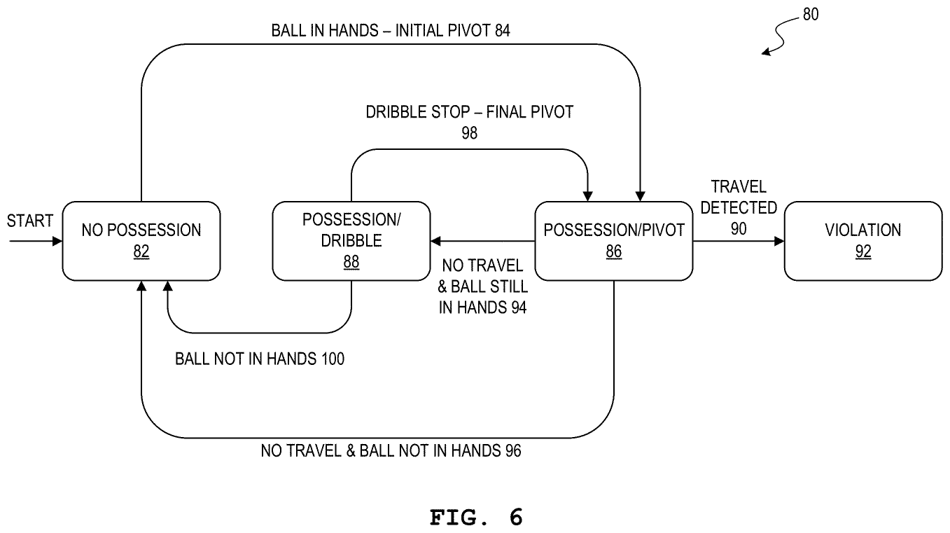

FIG. 5 shows an example machine-learning system 60 configured to evaluate a participant of a sport in a manner consistent with the above teachings. The system 60 may be used with the computing device 10 or system 50 discussed above. The system 60 may be implemented as processor-executable instructions 26, discussed above, and related data.

The machine-learning system 60 includes an equipment detector 62, a player detector 64, a player pose estimator 66, and a player state machine 68.

The equipment detector 62 may be configured to detect within captured images physical sports objects used in the sport, such as a ball, bat, stick, and so on.

The equipment detector 62 may include a trained object-detection model that is retrained using a new set of images that provide examples of the specific equipment (e.g., a ball) in different environments at different locations and orientations (if appropriate). The initial object-detecting model and the retraining may be done using the same programmatic tool, for example, a neural network capable of providing real-time object detection, such as You Only Look Once (e.g., YOLOv5, available at pytorch.org/hub/ultralytics_yolov5/).

The equipment detector 62 may implement interpolation, such as cubic interpolation, when the target piece of equipment is occluded from view in the captured images. That is, the equipment detector 62 may be configured to interpolate the position of the equipment in images where the equipment is not detected based on time-adjacent images where the equipment is detected. Cubic interpolation may be particularly useful due to the smoothness it can achieve, particularly with regard to detecting a ball, as cubic interpolation can accurately represent expected ball trajectory when the ball is in a player's hands.

The player detector 64 may include a trained object-detection model that is retrained using a new set of images that provide examples of players in different locations and poses and in different environments. The player detector 64 may be similar to the equipment detector 62.

The player pose estimator 66 may connected to the player detector 64 to receive output from the player detector 64. The player pose estimator 66 may be configured to detect a pose of a player detected by the player detector 64. The player pose estimator 66 may apply predefined skeletal or musculoskeletal key points such as shoulders, elbows, hips, knees, ankles, heels, toes, and similar. The player pose estimator 66 may include a multi-person pose estimator, such as AlphaPose (github.com/MVIG-SJTU/AlphaPose) or FastPose (github.com/ZexinChen/FastPose). The key points may accord with the Halpe full body dataset (github.com/Fang-Haoshu/Halpe-FullBody), such as a 26-point configuration. The player post estimator 66 may further include a pose tracker, such as PoseFlow (github.com/YuliangXiu/PoseFlow), to track poses of different people in a sequence of captured image to help distinguish a player from spectators, bystanders, and other people.

The 26-point configuration may be as follows: 0) nose, 1) left eye, 2) right eye, 3) left ear, 4) right ear, 5) left shoulder, 6) right shoulder, 7) left elbow, 8) right elbow, 9) left wrist, 10) right wrist, 11) left hip, 12) right hip, 13) left knee, 14) right knee, 15) left ankle, 16) right ankle, 17) top of head, 18) neck, 19) hip/groin, 20) left big toe, 21) right big toe, 22) left small toe, 23) right small toe, 24) left heel, and 25) right heel.

A filter 70 may be provided to filter the output of the player detector 64 and/or player pose estimator 66. The filter 70 may be configured to distinguish players from other people, such as spectators, based on a filter criterion. An example filter criterion includes distance moved per unit time. Alternatively or additionally, the filter 70 may implement a classifier that is applied to the output of the player detector 64 and/or player pose estimator 66 to distinguish players from other people. The classifier may be trained with common movements and/or poses expected to be exhibited by the players.

A player detector 64 and player pose estimator 66 may be provided to each different sequence of images or video captured by different cameras of a multi-camera system, such as the system 50. This may be useful to determine player body part position and orientation if occlusion occurs. For example, a player's arm may be occluded from the perspective of one camera but may be visible from the perspective of another camera. Each camera may be provided with its own player detector 64 and player pose estimator 66, and thus a particular player may be identified multiple times, to reduce or eliminate uncertainty due to occlusion. The machine-learning system 60 may further include a correlator 72 to correlate different instances of the same player determined by the different sets of player detector 64 and player pose estimator 66. The correlator 72 may be provided with the viewpoints (i.e., position and orientation) of the cameras and may map the output of the player detector 64 and player pose estimator 66 to a global coordinate system. The correlator 72 may then match different instances of players and their poses based on locations and/or orientations that are within a threshold distance or angle in the global coordinate system. For example, head positions determined from different cameras may be resolved to a common coordinate system and head positions within a threshold distance (e.g., 5 cm) may be determined to belong to the same player.

The player state machine 68 may be provided with output of the player detector 64, player pose estimator 66, and or equipment detector 62. Such information may be parsed into low-level classifications that indicate fundamental attributes of the player and the equipment as detected or inferred from the image data. Examples of such classifications include ball in hands, left foot on ground, right foot on ground, etc. Classifications may be expressed as Boolean values, such as possession=true.

The player state machine 68 may be configured to model valid sequences of movements between player states 74. The player state machine 68 may define transition conditions 76 to switch between states 74.

Each state 74 of the player state machine 68 defines either an allowable state or a rule violation state. Each state 74 has one or more exit conditions 76 to transition to another state. A state 74 may have one or more entry conditions (i.e., exit conditions 76 from other states 74) and one or more exit conditions 76. A state's exit conditions 76 are mutually exclusive to allow unambiguous determination of a next state. Each state's exit conditions 76 may be evaluated continuously, such as at a high frequency (e.g., 10, 20, or 30 times per second). Conditions are evaluated based on output obtained from the equipment detector 62 and the player detector 64 and player pose estimator 64.

The player state machine 68 may output an indication, such as trigger an alert 78, if the player is detected to transition from an allowable state to a non-allowable state (e.g., a rule violation state). For instance, if a player has transitioned out of a pivoting state by moving a pivot foot without previously releasing the ball, a pivot rule violation may be detected when the corresponding violation state becomes active. The system 60 may issue the alert 78 by emitting a sound, displaying a message, flashing a light, and/or communicating a signal to a computing device of an official (e.g., device 56 of FIG. 4). The official's device may additionally or alternatively emit a sound, display a message, flash a light, etc. to signal the violation.

Multiple player state machines 68 may be provided for multiple rules or training goals. These state machines 68 may be operated concurrently and the machine-learning system 60 may output an indication of current states for all state machines 68, so that a human operator can monitor for various rules violations or training goals.

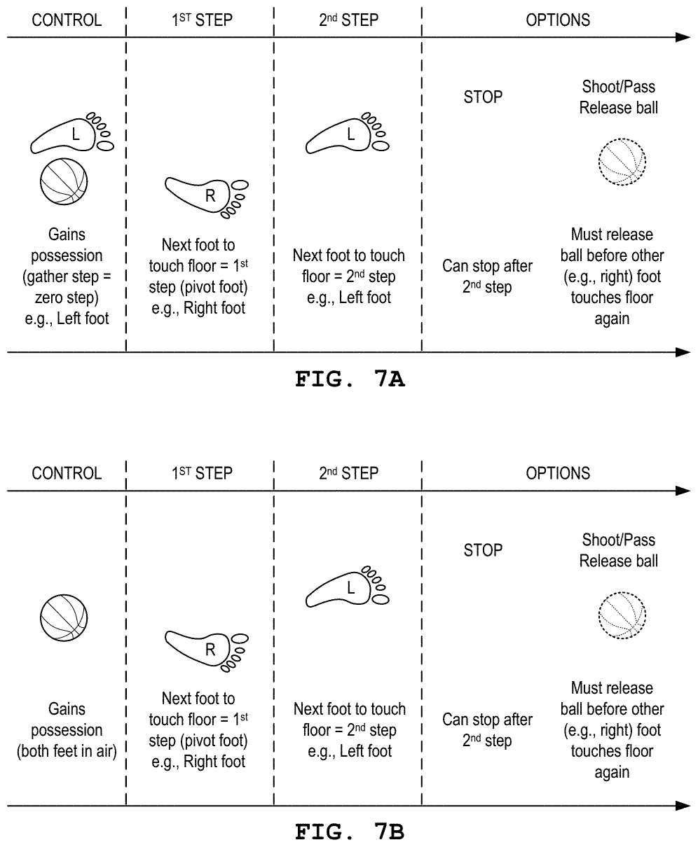

FIG. 6 shows an example player state machine 80 for a pivoting violation in basketball. Player states are interconnected by the conditions of possession detection and/or traveling detection. State switching occurs if a required condition is met. Conditions are defined with reference to the output of the equipment detector 62 and the player detector 64 and player pose estimator 64.

A possession detection condition is performed using position and motion information about player's hands and the ball. If the ball is within a threshold distance of the appropriate hand (or both hands) and is moving in the same direction as the appropriate hand (or both hands), then the player is considered to be in possession of the ball.

Traveling detection may be performed when a possession/pivot state is active. That is, traveling detection may be limited to being performed during this state so that unnecessary computations are avoided. The trajectories of both feet may be determined and the foot that moves the least may be determined to be the pivot foot. The degree to which a foot is stationary may be estimated using a foot trajectory variance. Relevant key points used for foot trajectory detection are the ankles, toes, and heels. As for determining a violation, if the pivot foot is detected to be lifted and then replaced on the surface while the ball is still in the player's possession, a traveling violation is determined. Otherwise, there is no traveling violation. Whether the foot is being lifted or placed back on the surface may be detected using foot movement and orientation.

With regard to FIG. 6, the detection process starts with a no possession state 82 as the default state. When an initial possession condition 84 is detected, a possession/pivot state 86 becomes active. Note that pivoting may not occur after the player's initial contact with the ball (initial pivot) and, in that case, state is immediately changed to a possession/dribble state 88. If a traveling condition 90 is detected, then a violation state 92 becomes active and an alert may be issued. If the traveling condition 90 is not detected and a condition 94 is met in which the ball is still in the player's hands, the possession/dribble state 88 becomes active. If the traveling condition 90 is not detected and a condition 96 is met in which the ball is no longer in player's hands (i.e., it was passed or a shot was taken), the no possession state 82 becomes active. If the possession/dribble state 88 is active and a condition 98 of the player stopping to dribble the ball is detected, then the position/pivot state 86 becomes active. Alternatively, if a condition 100 in which the player has lost the ball is detected, then the no possession state 82 becomes active.

### EXAMPLE

An example of the machine-learning system 60 was built and tested for a basketball pivoting violation, as defined by World Association of Basketball Coaches (WABC). The pivoting violation was modeled with a player state machine 68, 80 as follows. The system implementation utilized the machine learning modules YoloV5 and AlphaPose mentioned earlier.

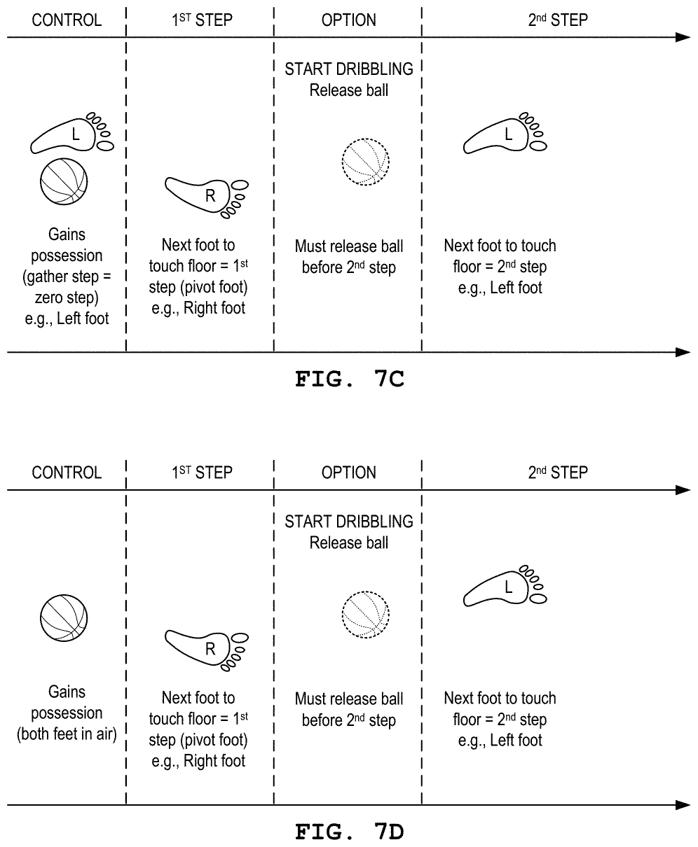

In a first case, with reference to FIGS. 7A and 7B, after taking possession of the ball on the move (progressing), a player can now take two steps before stopping, shooting, or passing. If the ball is obtained while one foot is touching the floor (upon dribbling or after passing while progressing), the NEXT foot (AFTER obtaining) to touch the floor is the first step (FIG. 7A). When the ball is obtained with both feet in the air, the NEXT foot to touch the floor is the first step, i.e., the pivot foot (FIG. 7B).

In a second case, with reference to FIGS. 7C and 7D, if a player wants to start dribbling while in motion, the ball must be released before the second step. When the ball is received when one foot is touching the floor (while in motion), the NEXT foot (AFTER receiving the ball) to touch the floor is first step and the ball must be released before the second step (in example left foot touches the floor) to start the dribble (FIG. 7C). When the ball is received in the air, the NEXT foot to touch the floor is the first step (the pivot foot) and the ball must be released before the second step to start the dribble (FIG. 7D).

The equipment detector 62 was retrained with approximately 900 images, split into training, testing, and validation sets, for 100 epochs using a YOLOv5 architecture. The YOLOv5 version was v6.0-192-g436ffc4, the PyTorch version was 1.9.0+cu102, the processor was a graphics processing unit (GPU) Tesla V100-PCIE-32GB (32510 MiB), and the training time was 2 hours and 5 minutes. The following parameters were used: learning rate=0.01, weight decay=0.0005, batch size=16, image size=640.

The model F1-score was 0.98. The mAP@.5 was 0.986, where mAP@.5 is the “mean Average Precision” with 0.5 as the Intersection over Union (IoU) threshold, IoU being an evaluation metric used to measure the accuracy of an object detector on a particular dataset. The mAP@.5:.95 was 0.824, where mAP@.5:.95 is the average mean Average Precision with IoU thresholds ranging from 0.5 to 0.95 with steps of 0.05.

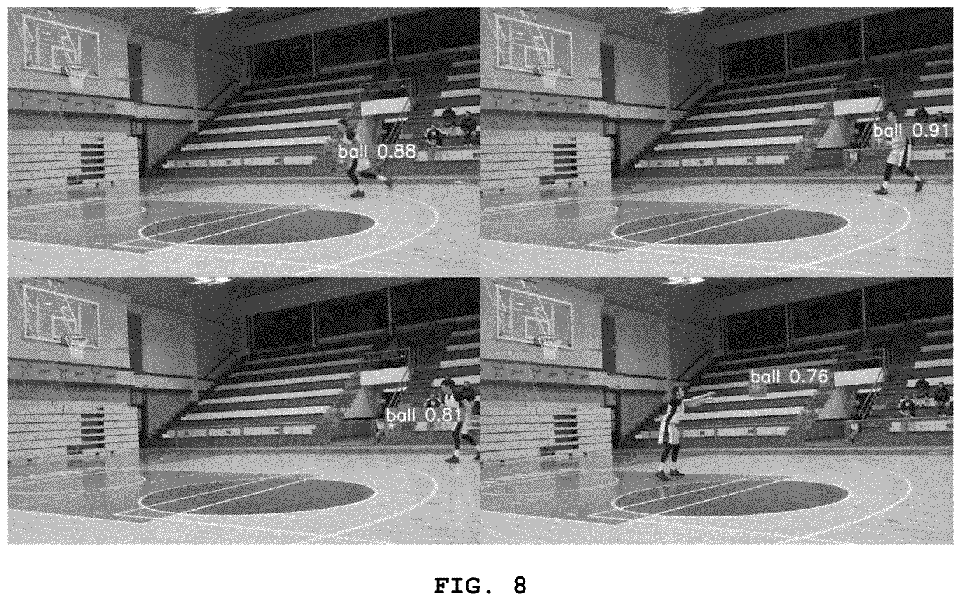

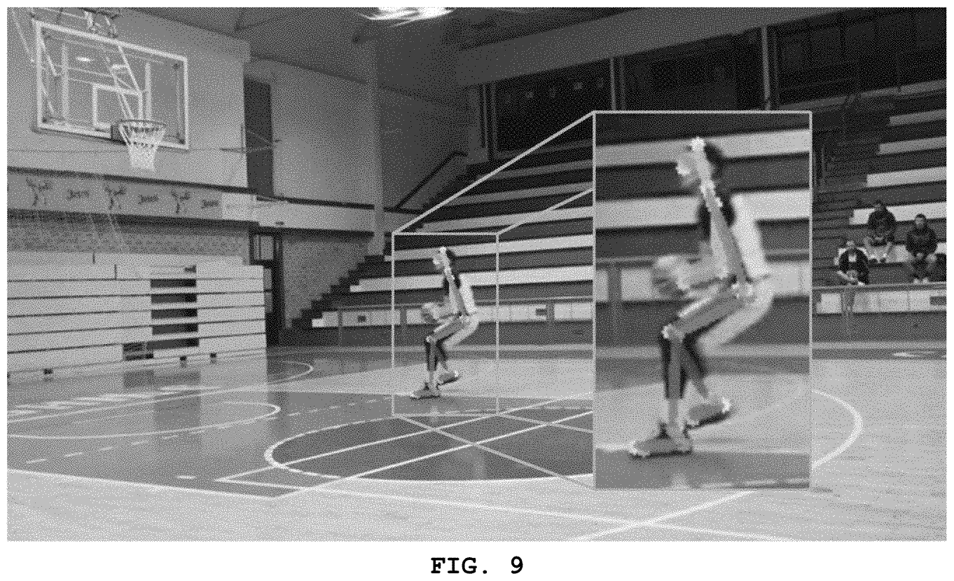

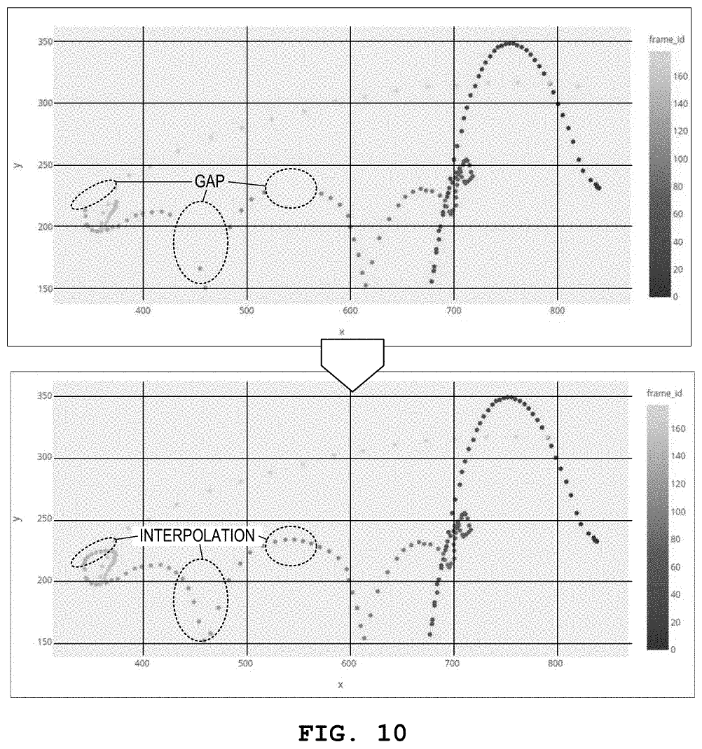

Examples of ball detection instances obtained with the equipment detector 62 configured in this manner are shown in FIG. 8, which shows confidence levels for each detection. FIG. 9 shows an example of the player detector 64 and player pose estimator 66 detecting a player and determining the pose of the player. Examples of cubic interpolation performed with the equipment detector 62 are shown in FIG. 10, which shows a detected ball trajectory with gaps in detection that were successfully interpolated.

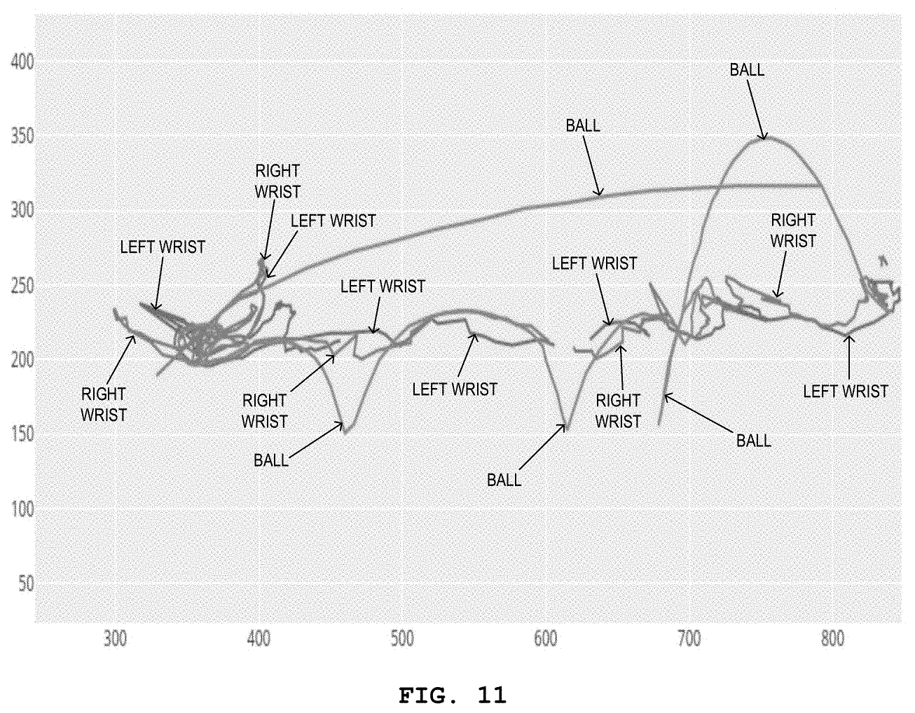

FIG. 11 shows detected relative positions between the player's hands and the ball. This is a visualization of the input provided to the player state machine 68.

Given the teachings above, any rules violation or coaching objective may be modeled and automatically detected with the techniques discussed herein. For example, double dribbling, carrying, and other basketball rules violations may be detected in the same or similar manner. Further, although the techniques discussed herein are particularly suited for basketball, it should be understood that they may be applied to other sports activities as well.

In view of the above, it should be apparent that subjectivity of coaches or officials can be replaced or augmented with machine-learning, so as to improve the objectivity of enforced rule violations or improve other actions taken by a player.

It should be recognized that features and aspects of the various examples provided above can be combined into further examples that also fall within the scope of the present disclosure. In addition, the figures are not to scale and may have size and shape exaggerated for illustrative purposes.

1. A method of detecting a rule violation in basketball, the method comprising:
capturing image data of a player of basketball;
processing the image data using a trained machine-learning system, the trained machine-learning system including a player state machine that describes allowable states of the player and a rule violation state of the player;
applying information extracted from the image data to the player state machine to determine whether the rule violation state is active; and
when the rule violation state is determined to be active, outputting an indication that the rule violation state is active.

2. The method of claim 1, comprising outputting the indication that the rule violation state is active to a computing device of an official of the sport.

3. The method of claim 1, further comprising:
receiving a selection of a specific rule violation associated with the image data; and
configuring the trained machine-learning system based on the specific rule violation.

4. The method of claim 1, wherein capturing the image data of the player comprises capturing the image data from different viewpoints around the player.

5. The method of claim 1, wherein the trained machine-learning system comprises a neural network.

6. The method of claim 1, further comprising determining which player of a plurality of players is in possession of a basketball.

7. A computing device comprising:
a camera aimed at a play volume that contains a player of basketball; and
a processor connected to the camera, the processor configured to:
receive image data of the player from the camera;
process the image data using a trained machine-learning system, the trained machine-learning system including a player state machine that describes allowable states of the player and a rule violation state of the player;
apply information extracted from the image data to the player state machine to determine whether the rule violation state is active; and
when the rule violation state is determined to be active, output an indication that the rule violation state is active.

8. The computing device of claim 7, further comprising a communications interface connected to the processor, wherein the processor is further configured to output the indication that the rule violation state is active to a computing device of an official of the sport via the communications interface.

9. The computing device of claim 7, wherein the processor is further configured to:
receive a selection of a specific rule violation associated with the image data; and
configure the trained machine-learning system based on the specific rule violation.

10. The computing device of claim 7, comprising a plurality of cameras aimed at the play volume, the plurality of cameras to capture the image data from different viewpoints around the player.

11. The computing device of claim 7, wherein the trained machine-learning system comprises a neural network.

12. The computing device of claim 7, wherein the processor is further configured to determine which player of a plurality of players is in possession of a basketball.

13. A non-transitory machine-readable medium comprising instructions that, when executed by a processor, cause the processor to:
receive image data of a player of basketball;
process the image data using a trained machine-learning system, the trained machine-learning system including a player state machine that describes allowable states of the player and a rule violation state of the player;
apply information extracted from the image data to the player state machine to determine whether the rule violation state is active; and
when the rule violation state is determined to be active, output an indication that the rule violation state is active.

14. The non-transitory machine-readable medium of claim 13, wherein the instructions are further to output the indication that the rule violation state is active to a computing device of an official of the sport.

15. The non-transitory machine-readable medium of claim 13, wherein the instructions are further to:
receive a selection of a specific rule violation associated with the image data; and
configure the trained machine-learning system based on the specific rule violation.

16. The non-transitory machine-readable medium of claim 13, wherein the image data is based on different viewpoints around the player.

17. The non-transitory machine-readable medium of claim 13, wherein the trained machine-learning system comprises a neural network.

18. The non-transitory machine-readable medium of claim 13, wherein the instructions are further to determine which player of a plurality of players is in possession of a basketball.
